(19) United States
(12) Patent Application Publication
(10) Pub. No.: US 2026/0121949 A1
(43) Pub. Date: Apr. 30, 2026

(54) USE OF NF SERVICE DISCOVERY IDENTIFIERS IN SUBSCRIBER-SPECIFIC PROCEDURES

(71) Applicant: T-Mobile USA, Inc., Bellevue, WA (US)

(72) Inventors: Rahul Amin, Issaquah, WA (US); Shane Metcalf, Bellevue, WA (US); Saravana Velusamy, Overland Park, KS (US)

(21) Appl. No.: 18/928,854

(22) Filed: Oct. 28, 2024

(51) Int. Cl. H04L 41/50; H04L 41/5061; H04L 69/22

(52) U.S. Cl. CPC H04L 41/5058; H04L 41/5061; H04L 69/22

(57) ABSTRACT

Computing devices(s) that, when executed, configure a first network function (NF) are described herein. The first NF is configured to include a network function (NF) service discovery identifier in a header of a NF service discovery procedure when initiating the NF service discovery procedure for a second NF towards a network repository function (NRF). The first NF is also configured to include the NF service discovery identifier in headers of subscriber-specific procedures. Further, the computing device(s), when executed, correlate subscriber-specific procedure traces with NF service discovery procedure traces based on the NF service discovery identifier.

### BACKGROUND

Call requests, such as a call attach, invoke multiple procedures, but only some of these procedures contain subscriber-specific parameters that enable the procedures to be stitched by tracing tools into call flows. Other invoked procedures, such as network function (NF) service discovery procedures, do not include subscriber-specific parameters and cannot be stitched into a call flow on the basis of subscriber-specific parameters. The use of subscriber-specific parameters for stitching a call flow is important as it allows analysis of a call flow by international mobile subscriber identity (IMSI) or mobile station international subscriber directory number (MSISDN). A user desiring to analyze tracing tool output for an IMSI or MSISDN (e.g., for a call failure) can only obtain a partial call flow for it and must manually data mine stored network traffic for procedures that are not included, such as the NF service discovery procedures. This can delay issue resolution and lead to degraded network quality and poor customer experience.

### BRIEF DESCRIPTION OF THE DRAWINGS

The detailed description is set forth with reference to the accompanying figures. In the figures, the left-most digit(s) of a reference number identifies the figure in which the reference number first appears. The same reference numbers in different figures indicate similar or identical items.

FIG. 1 shows computing device(s) that configure a first network function (NF) to include NF service discovery identifiers in both procedures that include subscriber-specific identifiers and that that do not, that gather traces of those procedures, and that correlate the traces based on the NF service discovery identifiers.

FIG. 2 shows a Fifth Generation (5G) core network with a probing system deployed within it to provide input to a tracing tool for the tracing tool to generate end-to-end call flow traces for subscriber-specific identifiers.

FIG. 3 is a flow diagram of an illustrative process for configuring a first NF to include NF service discovery identifier(s) in headers of NF service discovery procedures and headers of subscriber-specific procedures and for correlating traces for these procedures based on the NF service discovery identifier(s).

FIG. 4 is a schematic diagram of a computing device capable of implementing functionality of the tracing tool, repository, and/or probe(s).

### DETAILED DESCRIPTION

This disclosure is directed in part to techniques for configuring a first network function (NF). The first NF is configured to include a NF service discovery identifier in a header of a NF service discovery procedure when initiating the NF service discovery procedure for a second NF towards a network repository function (NRF). The first NF is also configured to include the NF service discovery identifier in headers of subscriber-specific procedures. Further, a tracing tool, making use of traces from the procedures, correlates subscriber-specific procedure traces with NF service discovery procedure traces based on the NF service discovery identifier. The result is inclusion of NF service discovery procedure traces that lack subscriber-specific identifiers with subscriber-specific procedure traces that include subscriber-specific identifiers. Such a result enables end-to-end call flow traces that can be queried based on a subscriber-specific identifier, such as an international mobile subscriber identity (IMSI) or a mobile station international subscriber directory number (MSISDN).

While mention is made throughout to a “first NF” querying about a second NF, it is to be understood that many NFs, perhaps each NF, may be a “first NF”—the second NF for one “first NF” may be the “first NF” for other NF(s). When correlating traces, traces from queries made by these potentially multiple “first NFs”may be correlated together.

In various implementations, the first NF may engage in many NF service discovery procedures for a given subscriber connection, such as a voice call or video call. These many procedures may include GET procedures, PUT procedures and others and may be directed at an NRF to discover which specific network functions to use. For instance, if there are two CHF NFs, CHF1 and CHF2, the first NF may send a GET to the NRF for the specific one of CHF1 and CHF2. With that GET, the first NF may include in its header an NF service discovery identifier. The result returned from the NRF may then be stored in a table of the first NF in association with the NF service discovery identifier. The table constructed may include a plurality of NF service discovery identifiers, such as one for each pair of a first NF with a second NF. Examples of NFs in such pairs may include an access and mobility management function (AMF), an authentication server function (AUSF), a unified data management node (UDM), a policy control function (PCF), a charging function (CHF), or a service management function (SMF).

The first NF may also engage in subscriber-specific procedures with the identified NFs. These subscriber-specific procedures may include an IMSI or a MSISDN. And based on the configuring of the first NF described herein, the subscriber-specific procedures may also include one or more NF service discovery identifiers (e.g., the NF service discovery identifier associated with the pair of the first NF and the recipient NF).

In some implementations, the traces gathered in the probe network by a tracing tool and stored in an associated repository may include the NF service discovery identifiers in headers of the traced procedures. As described, when the tracing tool receives an IMSI or MSISDN, the tool retrieves the subscriber-specific procedure traces associated with that IMSI or MSISDN and also some NF service discovery procedure traces that do not include the IMSI or MSISDN. It does so based on NF service discovery identifiers of those NF service discovery procedure traces being included in headers of the subscriber-specific procedure traces. The tracing tool may then stitch together those two sets of traces into an end-to-end call flow and return to the source of the IMSI/MSISDN.

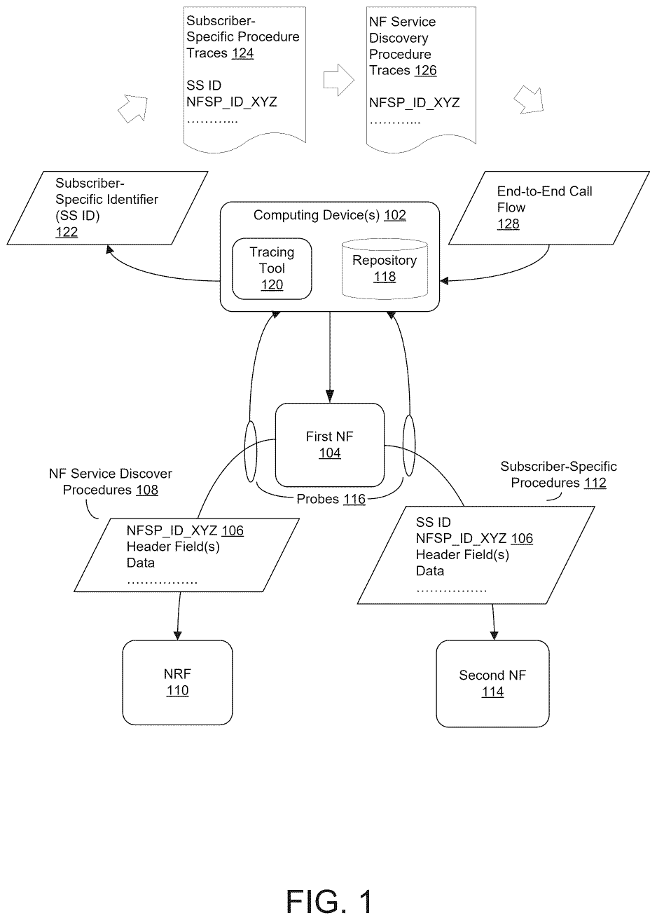

FIG. 1 shows computing device(s) that configure a first NF to include NF service discovery identifiers in both procedures that include subscriber-specific identifiers and that that do not, that gather traces of those procedures, and that correlate the traces based on the NF service discovery identifiers. As illustrated, computing device(s) 102 may configure a first NF 104 to include NF service discovery identifiers 106 in headers of NF service discovery procedure 108 sent to an NRF 110 and in headers of subscriber-specific procedures 112 sent to a second NF 114. Probes 116 throughout the connections between 5G core network nodes, such as between the first NF 104 and NRF 110 and between the first NF 104 and second NF 114, may gather traces for these procedures 108 and 112 in a repository 118. A tracing tool 120 may then retrieve ones of the traces, such as subscriber-specific procedure traces 124 and NF service discovery procedure traces 126, from the repository 118 in response to a query specifying a subscriber specific identifier 122. The tracing tool 120 may then stitch the traces 124 and 126 together into an end-to-end call flow 128 and return it as a result to the source of the query.

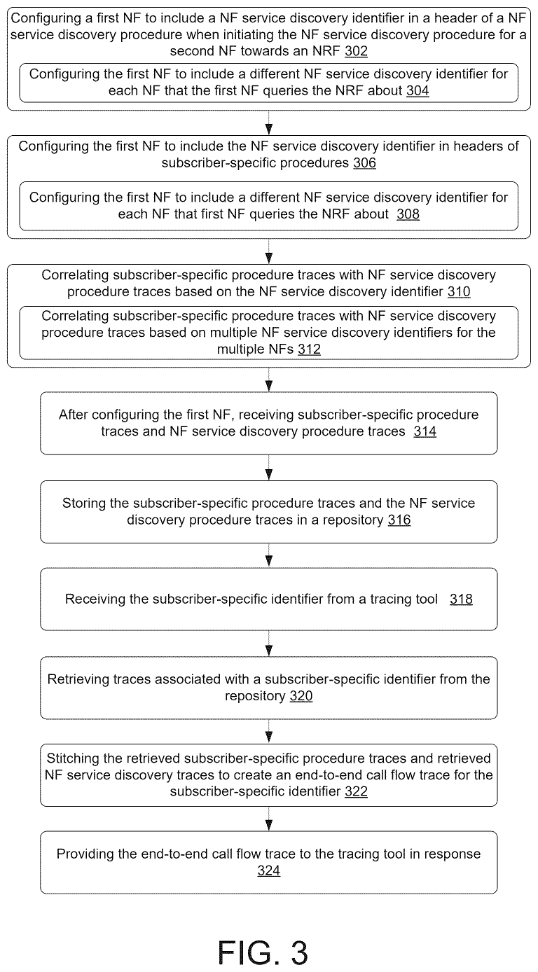

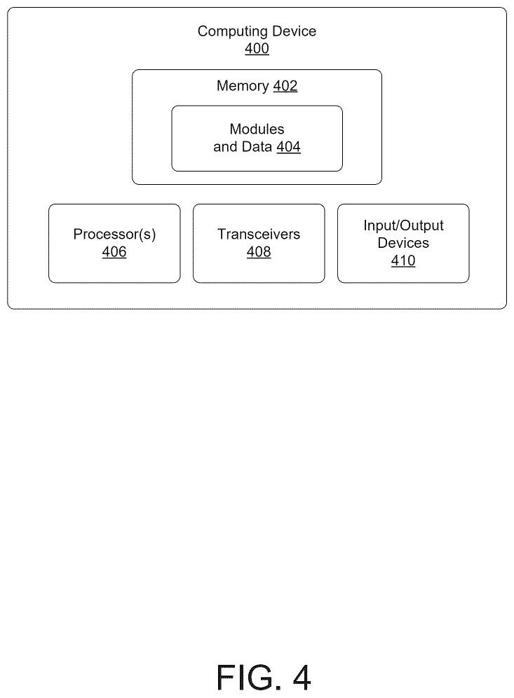

In various implementations, the techniques described herein may be performed by computing device(s) 102. Such computing device(s) 102 may comprise a monitoring system, analysis system, remediation system etc. integrated with a probe network having probes deployed in a consumer-facing network or lab network. The computing device(s) 102 may include at least a tracing tool 120 and repository 118. The operations of the techniques, implemented by the one or more computing devices, are shown in greater detail as the flow chart of FIG. 3 and are also described further herein. Additionally, an example computing device capable of serving as the one or more computing devices (or as one of such devices) is illustrated in FIG. 4 and is described further herein.

Additionally, the computing device(s) 102 may include separate components for configuring the first NF 104, or the tracing tool 120 may be the component(s) that configure the first NF 104. When the first NF 104 configuration is done by separate component(s), those component(s) may be implemented on different computing device(s) 102 from the computing device(s) that include the tracing tool 120 and repository 118.

In various implementations, the first NF 104 may perform control plane signaling associated with discovery of specific instances of node types of a 5G core network. For instance, the first NF 104 may be configured to communicate with the NRF 110 to discover specific instances of an AMF, an AUSF, a UDM, a PCF, a CHF, an SMF, etc. for a data connection associated with a subscriber device, such as a user equipment (UE). The UE may have initiated a voice call or video call, resulting in a packet data unit (PDU) connection message being sent to the first NF 104. Such a PDU connection may include a subscriber-specific identifier, such as an IMSI or MSISDN. The service discovery messages sent to the NRF 110—through NF service discovery procedures 108—may lack a subscriber-specific identifier.

Instead of a subscriber-specific identifier, the first NF 104 may be configured by the computing device(s) 102 to include a NF service discovery identifier 106 in the NF service discovery procedures 108 sent to the NRF 110. The NF service discovery identifier 106 may be any sort of alphanumeric identifier of any data type that can be used to specify a combination of the first NF 104 and a specific instance of a 5G core network node (i.e., NF). For example, the NF service discovery identifier 106 could include an identifier of the first NF 104 concatenated with an identifier of the NF type sought (e.g., CHF) and a numeric string unique to the first NF 104 identifier and NF type sought.

In some implementations, an NF service discovery procedure 108 can include at least an HTTP2 header, and the NF service discovery identifier 106 may be included in the HTTP2 header. The NF service discovery procedure 108 can also include in its header or somewhere in its message(s) an identifier of the requestor NF type (i.e., first NF) an identifier of the NF type being sought, and an indication of a locality for the specific instance of the target NF type. These parameters may be part of a GET message or other message(s) of an NF service discovery procedure 108.

The NRF 110, receiving these parameters, may utilize them to select a specific instance of the target NF type sought. For instance, if there are two instances of the CHF type, the NRF 110 may select one of these—e.g., CHF1—and notify the first NF 104, in response to the NF service discovery procedure 108, of the specific NF chosen.

The first NF 104 may then create or update a table or other data structure to store mappings of the NF service discovery identifier 106, the parameters included in the NF service discovery procedure 108, and the specific NF returned in response (e.g., CHF1). Each set of different parameters included in the NF service discovery procedure 108 and specific NF may be associated with a different NF service discovery identifier 106.

In various implementations, the first NF 104 may also be configured by the computing device(s) 102 to include the NF service discovery identifier 106 for a specific NF (e.g., second NF 114) in the subscriber specific procedures 112 communicated with that second NF 114. The headers of the messages of such procedures 112, such as HTTP2 headers, may include at least the subscriber-specific identifier (e.g., IMSI, MSISDN) and the NF service discovery identifier 106 associated in the table/data structure stored at the first NF 104 with the second NF 114.

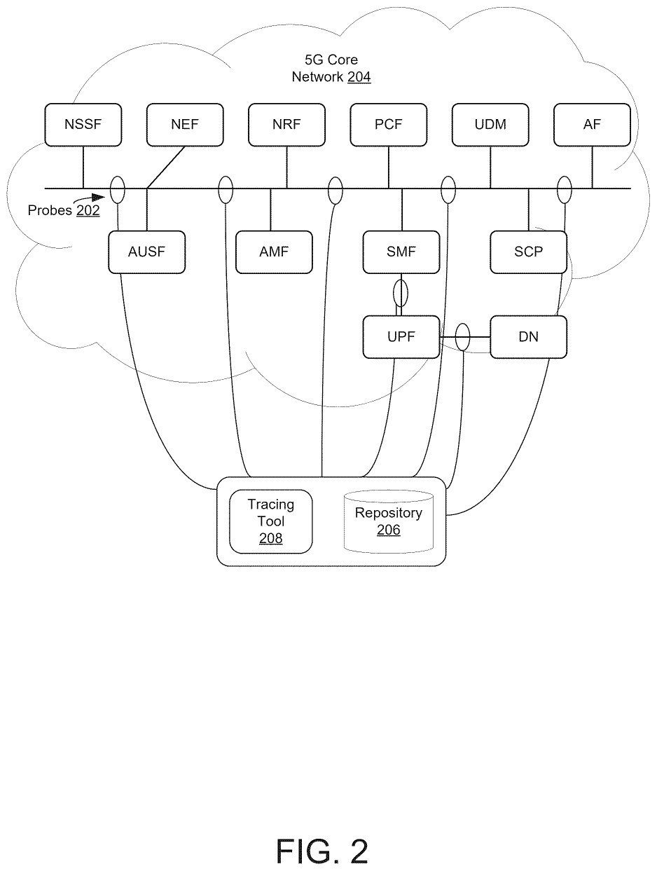

Probes 116 may gather traces of the procedures 108 and 112 (including headers) and store them in the repository 118. An example network of probes is illustrated in FIG. 2 and described in further detail with reference to that figure.

At some point in time after data is stored in the repository 118, the tracing tool 120 may be used (e.g., by an engineer or program) to investigate a call failure or other call, communication, or connection issue associated with a subscriber-specific identifier (e.g., subscriber-specific identifier 122). In such circumstances, the tracing tool 120 may retrieve from the repository 118 traces associated with the subscriber-specific identifier 122. The retrieved traces may include traces 124 of subscriber-specific procedures that included the subscriber-specific identifier 122 in their headers. The retrieved traces may also include traces 126 of NF service discovery procedures that do not include the subscriber-specific identifier 122. The tracing tool 120 may identify these traces 126 by way of NF service discovery identifiers. Any NF service discovery identifier that appears in the traces 124 of subscriber-specific procedures may be used by the tracing tool 120 to query the repository 118 traces 126 of NF service discovery procedures that include that/those NF service discovery identifier(s).

In various implementations, upon retrieving the traces 124 and 126, the tracing tool may stitch the traces 124 and 126 into an end-to-end call flow 128 for the subscriber-specific identifier 122 and return that end-to-end call flow 128 as a result for the investigated failure/issue.

FIG. 2 shows a 5G core network with a probing system deployed within it to provide input to a tracing tool for the tracing tool to generate end-to-end call flow traces for subscriber-specific identifiers. As shown, the probes 202 may be deployed throughout a 5G core network 204 such that network traffic between any two nodes of the 5G core network 204 may be echoed by the probes 202 to a repository 206 associated with a tracing tool 208. The tracing tool 208 may then utilize the information stored in the repository 206 to perform various types of network analysis, such as call flow traces.

In some examples, the 5G core network 204 can represent a service-based architecture that includes multiple types of NFs that process control plane data and/or user plane data to implement services for user devices, such as UEs. In some examples, the services comprise rich communication services (RCS), a voice-over-New-Radio (VoNR) service, a video-over-New-Radio (ViNR) service, and the like which may include a text, a data file transfer, an image, a video, or a combination thereof. The NFs of the 5G core network 204 can be examples of the NFs 104 and 114 as well as of NRF 110. For example, the NFs of the 5G core network 204 can include an AMF, an SMF, a User Plane Function (UPF), a PCF, and/or other NFs implemented in software and/or hardware. Other examples may include an AUSF, a Data Network (DN), an Unstructured Data Storage Function (UDSF), a Network Exposure Function (NEF), an NRF, a Network Slice Selection Function (NSSF), a UDM, a Unified Data Repository (UDR), an Application Function (AF), a 5G-Equipment Identity Register (5G-EIR), a Network Data Analytics Function (NWDAF), a CHF, a Service Communication Proxy (SCP), a Security Edge Protection Proxy (SEPP), a Non-3GPP InterWorking Function (N3IWF), a Trusted Non-3GPP Gateway Function (TNGF), and/or a Wireline Access Gateway Function (W-AGF), many of which are shown in FIG. 2 as part of the 5G core network 204.

The 5G core network 204 can, in some examples, determine a connection between an Internet Protocol (IP) multimedia subsystem (IMS) that manages communication sessions for a user device, including sessions for short messaging, voice calls, video calls, and/or other types of communications. Such user devices and the IMS can exchange Session Initiation Protocol (SIP) messages to set up and manage individual communication sessions.

As mentioned previously, the 5G core network 204 can be part of a consumer-facing or lab network, and probes 202 can be deployed among communication paths between the nodes of the 5G core network 204. The probes 202 can be examples of probes 116. As network traffic is carried between the nodes, the probes 202 may echo that traffic—without interrupting it—back to a repository 206.

The repository 206 and tracing tool 208 may be part of a monitoring or analysis system. In some implementations, the repository 206 may be an example of the repository 118 and the tracing tool 208 may be an example of the tracing tool 120. The repository 206 may be a database system that receives network traffic from the probes 202 and stores the network traffic. The tracing tool 208 may be any sort of tool, such as a tool for producing a call flow trace. In some examples, the tracing tool 208 may be a NetScout tool. Examples of the tracing tool 208, repository 206, and the one or more computing devices implementing them are described further herein in relation to FIGS. 1 and 3, and 4.

FIG. 3 illustrates an example process. This process is illustrated as logical flow graph, each operation of which represents a sequence of operations that can be implemented in hardware, software, or a combination thereof. In the context of software, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described operations can be omitted or combined in any order and/or in parallel to implement the processes.

FIG. 3 is a flow diagram of an illustrative process for configuring a first NF to include NF service discovery identifier(s) in headers of NF service discovery procedures and headers of subscriber-specific procedures and for correlating traces for these procedures based on the NF service discovery identifier(s). As illustrated at 302, one or more computing devices, such as those associated with a tracing tool or probing network system, may configure a first NF to include a NF service discovery identifier in a header of a NF service discovery procedure when initiating the NF service discovery procedure for a second NF towards the NRF. At 304, the configuring may include configuring the first NF to include a different NF service discovery identifier for each NF that first NF queries the NRF about. The NFs may include at least one of an AMF, an AUSF, a UDM, a PCF, a CHF, or an SMF.

At 306, the computing device(s) may configure the first NF to include the NF service discovery identifier in headers of subscriber-specific procedures. At 308, the configuring may include configuring the first NF to include a different NF service discovery identifier for each NF that first NF queries the NRF about.

At 310, the computing device(s) may correlate subscriber-specific procedure traces with NF service discovery procedure traces based on the NF service discovery identifier. At 312, the correlating may include correlating subscriber-specific procedure traces with NF service discovery procedure traces based on multiple NF service discovery identifiers for multiple NFs.

At 314, after configuring the first NF, the computing device(s) may receive subscriber-specific procedure traces and NF service discovery procedure traces and, at 316, may store the subscriber-specific procedure traces and the NF service discovery procedure traces in a repository.

At 318, the computing device(s) may receive a subscriber-specific identifier from a tracing tool. In response, at 320, the computing device(s) may retrieve traces associated with the subscriber-specific identifier from the repository. The traces associated with the subscriber-specific identifier may include subscriber-specific procedure traces associated with the subscriber-specific identifier and NF service discovery procedure traces with NF service discovery identifiers that were included in headers of the subscriber-specific procedure traces associated with the subscriber-specific identifier.

At 322, the computing device(s) may stitch the retrieved subscriber-specific procedure traces and retrieved NF service discovery traces to create an end-to-end call flow trace for the subscriber-specific identifier.

At 324, the computing device(s) may provide the end-to-end call flow trace to the tracing tool in response to the request received at 318.

FIG. 4 is a schematic diagram of a computing device capable of implementing functionality of the tracing tool, repository, and/or probe(s). As shown, the computing device 400 includes a memory 402 storing modules and data 404, processor(s) 406, transceivers 408, and input/output devices 410.

In various examples, the memory 402 can include system memory, which may be volatile (such as RAM), non-volatile (such as ROM, flash memory, etc.) or some combination of the two. The memory 402 can further include non-transitory computer-readable media, such as volatile and nonvolatile, removable and non-removable media implemented in any method or technology for storage of information, such as computer readable instructions, data structures, program modules, or other data. System memory, removable storage, and non-removable storage are all examples of non-transitory computer-readable media. Examples of non-transitory computer-readable media include, but are not limited to, RAM, ROM, EEPROM, flash memory or other memory technology, CD-ROM, digital versatile discs (DVD) or other optical storage, magnetic cassettes, magnetic tape, magnetic disk storage or other magnetic storage devices, or any other non-transitory medium which can be used to store the desired information.

The memory 402 can include one or more software or firmware elements, such as computer-readable instructions that are executable by the one or more processors 406. For example, the memory 402 can store computer-executable instructions associated with modules and data 404. The modules and data 404 can include a platform, operating system, and applications, and data utilized by the platform, operating system, and applications. Further, the modules and data 404 can implement any of the functionality for tracing tool 208, repository 206, probes 202, or any other node/device described and illustrated herein.

In various examples, the processor(s) 406 can be a central processing unit (CPU), a graphics processing unit (GPU), or both CPU and GPU, or any other type of processing unit. Each of the one or more processor(s) 406 may have numerous arithmetic logic units (ALUs) that perform arithmetic and logical operations, as well as one or more control units (CUs) that extract instructions and stored content from processor cache memory, and then executes these instructions by calling on the ALUs, as necessary, during program execution. The processor(s) 406 may also be responsible for executing all computer applications stored in the memory 402, which can be associated with types of volatile (RAM) and/or nonvolatile (ROM) memory.

The transceivers 408 can include modems, interfaces, antennas, Ethernet ports, cable interface components, and/or other components that perform or assist in exchanging wireless communications, wired communications, or both.

While the computing device need not include input/output devices 410, in some implementations it may include one, some, or all of these. For example, the input/output devices 410 can include a display, such as a liquid crystal display or any other type of display. For example, the display may be a touch-sensitive display screen and can thus also act as an input device or keypad, such as for providing a soft-key keyboard, navigation buttons, or any other type of input. The input/output devices 410 can include any sort of output devices known in the art, such as a display, speakers, a vibrating mechanism, and/or a tactile feedback mechanism. Output devices can also include ports for one or more peripheral devices, such as headphones, peripheral speakers, and/or a peripheral display. The input/output devices 410 can include any sort of input devices known in the art. For example, input devices can include a microphone, a keyboard/keypad, and/or a touch-sensitive display, such as the touch-sensitive display screen described above. A keyboard/keypad can be a push button numeric dialing pad, a multi-key keyboard, or one or more other types of keys or buttons, and can also include a joystick-like controller, designated navigation buttons, or any other type of input mechanism.

Although features and/or methodological acts are described above, it is to be understood that the appended claims are not necessarily limited to those features or acts. Rather, the features and acts described above are disclosed as example forms of implementing the claims.

Also, while the descriptions provided herein may be in the context of certain radio access technologies, networks, and network topologies, such as 5G/new radio (NR) mobile communications, the proposed concepts, schemes, and any variations thereof may be implemented in, for and by other types of radio access technologies, networks, and network topologies. Such radio access technologies, networks, and network topologies may include, for example and without limitation, Long-Term Evolution (LTE), Internet-of-Things (IoT), Narrow Band Internet of Things (NB-IoT), vehicle-to-everything (V2X), fixed wireless internet, and non-terrestrial network (NTN) communications. Thus, the scope of the disclosure is not limited to the examples described herein.

What is claimed is:

1. A method comprising:
configuring, by one or more computing devices, a first network function (NF) to include a NF service discovery identifier in a header of a NF service discovery procedure when initiating the NF service discovery procedure for a second NF towards a network repository function (NRF);
configuring, by the one or more computing devices, the first NF to include the NF service discovery identifier in headers of subscriber-specific procedures; and
correlating, by the one or more computing devices, subscriber-specific procedure traces with NF service discovery procedure traces based on the NF service discovery identifier.

2. The method of claim 1, wherein the first NF is one of an access and mobility management function (AMF), an authentication server function (AUSF), a unified data management node (UDM), a policy control function (PCF), a charging function (CHF), or a service management function (SMF).

3. The method of claim 1, wherein configuring the first NF to include the NF service discovery identifier comprises configuring the first NF to include a different NF service discovery identifier for each NF that first NF queries the NRF about.

4. The method of claim 3, wherein the first NF queries the NRF about multiple NFs, and the correlating comprises correlating subscriber-specific procedure traces with NF service discovery procedure traces based on multiple NF service discovery identifiers for the multiple NFs.

5. The method of claim 1, further comprising:
after configuring the first NF, receiving subscriber-specific procedure traces and NF service discovery procedure traces; and
storing the subscriber-specific procedure traces and the NF service discovery procedure traces in a repository.

6. The method of claim 5, further comprising retrieving traces associated with a subscriber-specific identifier from the repository, wherein the traces associated with the subscriber-specific identifier include subscriber-specific procedure traces associated with the subscriber-specific identifier and NF service discovery procedure traces with NF service discovery identifiers that were included in headers of the subscriber-specific procedure traces associated with the subscriber-specific identifier.

7. The method of claim 6, further comprising stitching the retrieved subscriber-specific procedure traces and retrieved NF service discovery traces to create an end-to-end call flow trace for the subscriber-specific identifier.

8. The method of claim 7, further comprising receiving the subscriber-specific identifier from a tracing tool and providing the end-to-end call flow trace to the tracing tool in response.

9. A system comprising:
one or more processors; and
programming instructions that, when executed by the one or more processors, cause one or more computing devices of the one or more processors to perform operations including:
configuring a first network function (NF) to include a NF service discovery identifier in a header of a NF service discovery procedure when initiating the NF service discovery procedure for a second NF towards a network repository function (NRF);
configuring the first NF to include the NF service discovery identifier in headers of subscriber-specific procedures; and
correlating subscriber-specific procedure traces with NF service discovery procedure traces based on the NF service discovery identifier.

10. The system of claim 9, wherein configuring the first NF to include the NF service discovery identifier comprises configuring the first NF to include a different NF service discovery identifier for each NF that first NF queries the NRF about.

11. The system of claim 10, wherein the first NF queries the NRF about multiple NFs, and the correlating comprises correlating subscriber-specific procedure traces with NF service discovery procedure traces based on multiple NF service discovery identifiers for the multiple NFs.

12. The system of claim 10, wherein the operations further include:
after configuring the first NF, receiving subscriber-specific procedure traces and NF service discovery procedure traces; and
storing the subscriber-specific procedure traces and the NF service discovery procedure traces in a repository.

13. The system of claim 12, wherein the operations further include retrieving traces associated with a subscriber-specific identifier from the repository, wherein the traces associated with the subscriber-specific identifier include subscriber-specific procedure traces associated with the subscriber-specific identifier and NF service discovery procedure traces with NF service discovery identifiers that were included in headers of the subscriber-specific procedure traces associated with the subscriber-specific identifier.

14. The system of claim 13, wherein the operations further include stitching the retrieved subscriber-specific procedure traces and retrieved NF service discovery traces to create an end-to-end call flow trace for the subscriber-specific identifier.

15. A non-transitory computer storage medium having programming instructions stored thereon that, when executed by one or more computing devices cause the one or more computing devices to perform operations comprising:
configuring a first network function (NF) to include a NF service discovery identifier in a header of a NF service discovery procedure when initiating the NF service discovery procedure for a second NF towards a network repository function (NRF);
configuring the first NF to include the NF service discovery identifier in headers of subscriber-specific procedures; and
correlating subscriber-specific procedure traces with NF service discovery procedure traces based on the NF service discovery identifier.

16. The non-transitory computer storage medium of claim 15, wherein configuring the first NF to include the NF service discovery identifier comprises configuring the first NF to include a different NF service discovery identifier for each NF that first NF queries the NRF about.

17. The non-transitory computer storage medium of claim 16, wherein the first NF queries the NRF about multiple NFs, and the correlating comprises correlating subscriber-specific procedure traces with NF service discovery procedure traces based on multiple NF service discovery identifiers for the multiple NFs.

18. The non-transitory computer storage medium of claim 15, wherein the operations further comprise:
after configuring the first NF, receiving subscriber-specific procedure traces and NF service discovery procedure traces; and
storing the subscriber-specific procedure traces and the NF service discovery procedure traces in a repository.

19. The non-transitory computer storage medium of claim 18, wherein the operations further comprise retrieving traces associated with a subscriber-specific identifier from the repository, wherein the traces associated with the subscriber-specific identifier include subscriber-specific procedure traces associated with the subscriber-specific identifier and NF service discovery procedure traces with NF service discovery identifiers that were included in headers of the subscriber-specific procedure traces associated with the subscriber-specific identifier.

20. The non-transitory computer storage medium of claim 19, wherein the operations further comprise stitching the retrieved subscriber-specific procedure traces and retrieved NF service discovery traces to create an end-to-end call flow trace for the subscriber-specific identifier.
